(19) United States
(12) Patent Application Publication
(10) Pub. No.: US 2005/0049725 A1
(43) Pub. Date: Mar. 3, 2005

(54) Synchronous system for virtual reality frame and real objects

(76) Inventor: Zyh-Ming Huang, Taipei Hsien (TW)

Correspondence Address: Zyh-Ming Huang, 235 Chung-Ho, Box 8-24, Taipei, TW

(21) Appl. No.: 10/646,303

(22) Filed: Aug. 25, 2003

(51) Int. Cl. G05B 11/01; G05B 19/18

(52) U.S. Cl. 700/19; 700/65; 700/66

(57) ABSTRACT

A synchronous system for a virtual reality frame and real objects is disclosed. A virtual reality system is installed to a mainframe with display frame. Objects in a room are installed with sensors and transmitters. Signals of these sensors are transmitted to a transceiver of the mainframe so that the mainframe knows the conditions of the object in the room. A plurality of toys are in a room. Actions of the toys are stored in the mainframe. The display of the mainframe has icons which represents the toys. The objects have corresponding icons in the virtual reality frame. The signals of the sensors are transmitted to the mainframe through the transmitter so that the virtual reality frame can show the result. The transceiver transmits the signals to the receiver so that the objects can act according to the received signals.

### FIELD OF THE INVENTION

The present invention relates to virtual realities, and particularly to a synchronous system for a virtual reality frame and real objects.

### BACKGROUND OF THE INVENTION

In the prior art virtual reality designs, only one scenery is provided which is used as a background. In front of the virtual reality frame is arranged with a machine, for example an exercising machine so that when the user uses the machine, the virtual reality frame is used as a background to increase the interest as the user uses the machine. However the prior art design is dull because the background is not vivid and is unchangeable.

### SUMMARY OF THE INVENTION

Accordingly, the primary object of the present invention is to provide a synchronous system for a virtual reality frame and real objects, which can provide very plentiful background, the background is changeable and is controllable by the users.

Another object of the present invention is to provide a synchronous system for a virtual reality frame and real objects, wherein the virtual reality frame is changeable according to the object to be simulated.

A further object of the present invention is to provide a synchronous system for a virtual reality frame and real objects, wherein the icons in the virtual reality frame represent some real objects, and the actions of the icons in the virtual reality frame are learnable so that the user can control. the real objects by the simulation in the virtual reality frame.

To achieve above object, the present invention provides a synchronous system for a virtual reality frame and real objects, wherein a virtual reality system is installed to a mainframe with display frame. Objects in a room are installed with sensors and transmitters. Signals of these sensors are transmitted to a transceiver of the mainframe so that the mainframe knows the conditions of the object in the room. A plurality of toys are in a room. Actions of the toys are stored in the mainframe. The display of the mainframe has icons which represents the toys. The objects have corresponding icons in the virtual reality frame. The signals of the sensors are transmitted to the mainframe through the transmitter so that the virtual reality frame can show the result. The transceiver transmits the signals to the receiver so that the objects can act according to the received signals.

The various objects and advantages of the present invention will be more readily understood from the following detailed description when read in conjunction with the appended drawing.

### BRIEF DESCRIPTION OF THE DRAWINGS

FIG. 1 shows the structure of the synchronous system for a virtual reality frame and real objects of the present invention.

FIG. 2 shows the flow diagram of the present invention.

FIG. 3 shows one example of the present invention.

FIG. 4 shows the arrangements in one embodiment of the present invention.

### DETAILED DESCRIPTION OF THE PREFERRED EMBODIMENTS

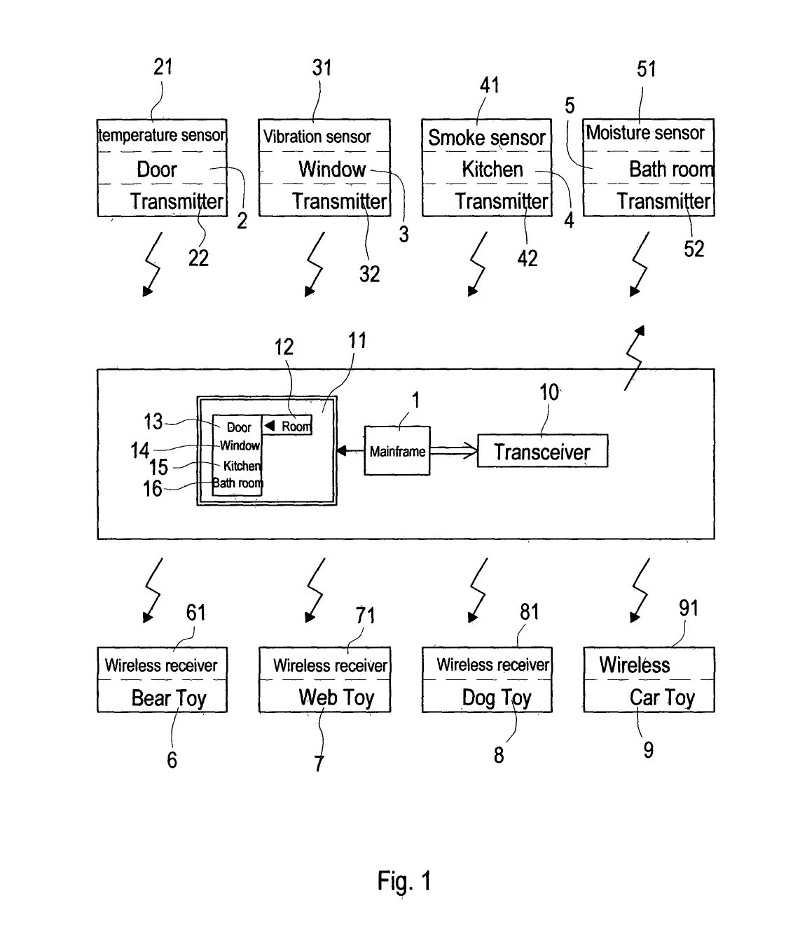

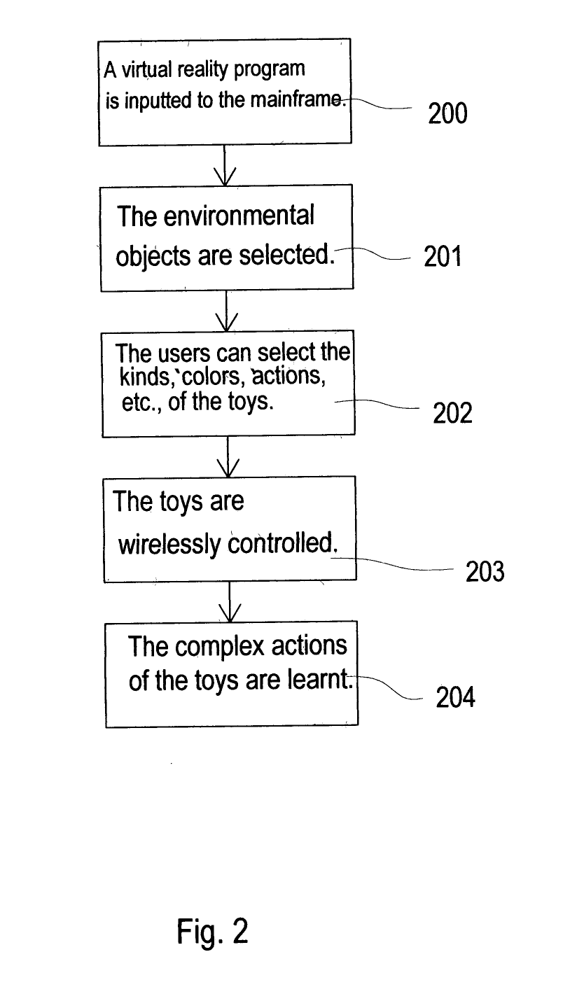

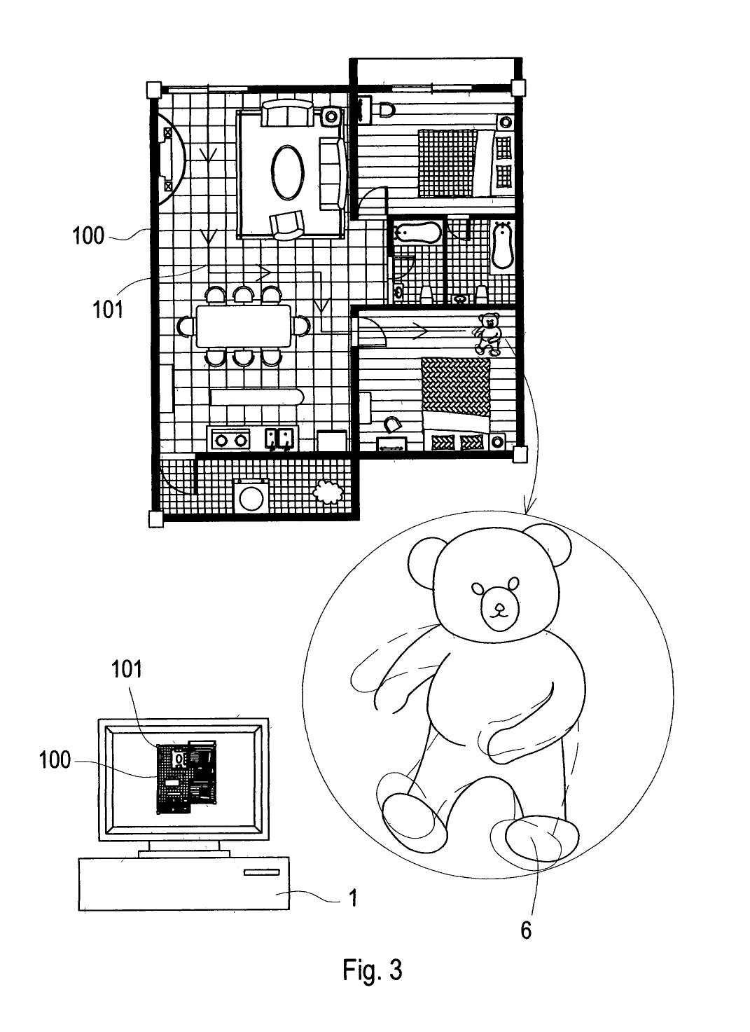

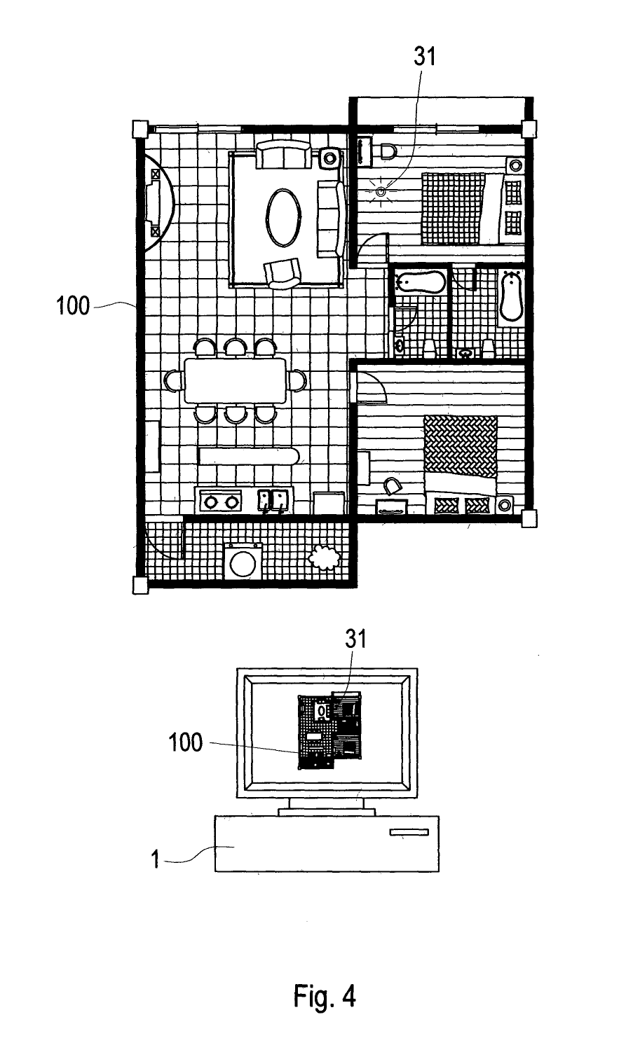

Referring to FIGS. 1 to 4, a synchronous system for a virtual reality frame and real objects is provided.

A virtual reality system is installed to a mainframe with display frame, such as a computer, a PDA, a game machine, etc.

The objects are installed with sensors and transmitters, for example, in a room 12, a door 13 is installed with a temperature sensor 21 and the transmitter 22, a window 3 is installed with a vibration sensor 31 and a transmitter 32, a kitchen 4 is installed with a smoke sensor 41 and a transmitter 33, and a bath room 5 is installed with a moisture sensor 51 and a transmitter 34, etc. Signals of these sensors are transmitted to a transceiver 10 of the mainframe 1 so that the mainframe can know the conditions of the object in the room.

Moreover, there are a plurality of toys in the room. Thus, the present invention is used to control toy models. For example, the toy bear 6 is installed with a wireless receiver 61, a toy web 7 is installed with a wireless receiver 71, a toy dog 8 is installed with a wireless receiver 81, and a toy car 9 is installed with a wireless receiver 91.

The actions of the toys can be stored in the mainframe 1. The display of the mainframe 1 has icons which represent the toys. Such as the moving path 101 of the bear 6 can be stored in the mainframe 1.

Above said objects have corresponding icons in the virtual reality frame. the signal of the sensors 21, 31, 41, 51 are transmitted to the mainframe 1 through the transmitter 22, 32, 42, and 51 so that the virtual reality frame can show the result.

The transceiver 10 transmits the signals to the receiver 61, 71, 81, and 91 so that the objects can act according to the received signals.

The step for executing the present invention will be described herein.

In step 200, a virtual reality program is inputted to the mainframe.

In step 201, the environmental objects, such as door, are selected. In the present invention, there are many icons which presents objects and toys being stored in the virtual reality program. The environmental objects are such as kitchen, bathing room, or outer doors objects, such as mountains, stars, moon, whether conditions, light, etc.

In step 202, the toys are selected. The users can select the kinds, colors, actions, etc., of the toys.

In step 203, the toys arc wirelessly controlled. The icons of the toys in the virtual reality frame can be operated manually and then the toys will act as the action of the toy in the virtual reality frame.

In step 204, the complex actions of the toys are learnt and the real toys can execute the complex action according to the learning result, In the present invention, a series of actions of the toys are learnt and are stored in the mainframe 1. Then the real toys can execute the complex actions according to the learning result.

Advantages of the present invention will be described hereinafter. The virtual reality icons act with the real objects or toys synchronously. The objects in the room are selected as desired. The learning mode can be used to simplify the control process. The icons in the virtual reality frame can interact with the real objects and toys.

1. A synchronous system for a virtual reality frame and real objects comprising:
a virtual reality system being installed to a mainframe with display frame called as a virtual reality frame, wherein the mainframe is selected from one of a computer, a PDA, and a game machine;
objects in a room being installed with sensors and transmitters, signals of these sensors being transmitted to a transceiver of the mainframe so that the mainframe knows the conditions of the object in the room; a plurality of object icons being present in the virtual reality frame;
a plurality of toys being in a room; a plurality of toy icons being presented in the virtual reality frame;
wherein the signal of the sensors are transmitted to the mainframe through the transmitters so that the virtual reality frame can show the result; and the transceiver transmits the signals to the receiver so that the toys act according to the received signals and the actions of the toys are displaced by the toy icons in the virtual reality frame.

2. The synchronous system for a virtual reality frame and real objects as claimed in claim 1, wherein the actions of the toys are programmed and then are stored in the virtual reality frame.

3. The synchronous system for a virtual reality frame and real objects as claimed in claim 1, wherein the objects in the room are simulated in the virtual reality program so that the users simulate conditions of the room in the virtual reality frame.

4. The synchronous system for a virtual reality frame and real objects as claimed in claim 1, wherein the actions of the toys are stored in the virtual reality program so that the user controls the toys by the stored actions of the toys.

5. The synchronous system for a virtual reality frame and real objects as claimed in claim 1, wherein a series of actions of the toy are learnt and the result of the actions are stored in the mainframe; the real toys execute the complex action according to the learning result.

6. The synchronous system for a virtual reality frame and real objects as claimed in claim 1, wherein a door is installed with a temperature sensor and the transmitter, a window is installed with a vibration sensor and a transmitter, a kitchen is installed with a smoke sensor and a transmitter, and a bath room is installed with a moisture sensor and a transmitter.

7. The synchronous system for a virtual reality frame and real objects as claimed in claim 1, wherein a toy bear is installed with a wireless receiver, a toy web is installed with a wireless receiver, a toy dog is installed with a wireless receiver, a toy car is installed with a wireless receiver.
